(19) United States
(12) Patent Application Publication
(10) Pub. No.: US 2025/0035508 A1
(43) Pub. Date: Jan. 30, 2025

(54) OPTICAL MODULE ADJUSTMENT METHOD AND EXAMINATION METHOD

(71) Applicant: Panasonic Intellectual Property Management Co., Ltd., Osaka (JP)

(72) Inventors: JUN YOKOYAMA, Osaka (JP); TATSUYA YONEMURA, Osaka (JP); TAKASHI URASHIMA, Osaka (JP); YOHEI TAKECHI, Osaka (JP); HIDEYUKI TACHIKA, Osaka (JP)

(21) Appl. No.: 18/917,559

(22) Filed: Oct. 16, 2024

Related U.S. Application Data
(63) Continuation of application No. PCT/JP2023/005268, filed on Feb. 15, 2023.

(30) Foreign Application Priority Data
Apr. 28, 2022 (JP) 2022-075287

(51) Int. Cl. G01M 11/02

(52) U.S. Cl. CPC G01M 11/0221; G01M 11/0242

(57) ABSTRACT

At least three light fluxes of the test pattern projected from optical module 1 are acquired by wavefront sensor 9, the parallelism of the respective light fluxes is calculated, and the orientation of display panel 5 of the optical module is adjusted so that the parallelism of each light flux coincides.

### TECHNICAL FIELD

The present disclosure relates to an adjustment method and an examination method for an optical module that projects light or video.

### BACKGROUND ART

PTL 1 discloses an adjustment device of an optical module of a liquid crystal projector. The adjustment device of the optical module adjusts and fixes the position and orientation of a liquid crystal panel mounted on the optical module in order to suppress the blur of the projected image on the screen from the optical module.

Here, an adjustment device of an optical module of PTL 1 will be described with reference to FIG. 12. FIG. 12 is a diagram schematically illustrating a configuration of adjustment device 101 for an optical module disclosed in PTL 1.

Optical module 105 being assembled including liquid crystal panel 102 that displays a video, prism 103, and projection lens 104 that projects a video is installed in adjustment device 101. Liquid crystal panel 102 is connected to control device 106. Liquid crystal panel 102 is held by robot 107 that adjusts the position and orientation of liquid crystal panel 102.

The position and orientation of liquid crystal panel 102 are adjusted as follows.

A test pattern is displayed on liquid crystal panel 102 according to a command from control device 106. The pattern displayed on liquid crystal panel 102 is formed and displayed on transmissive screen 108 via prism 103 and projection lens 104. The test pattern displayed on transmissive screen 108 is imaged by camera 109, and the state of the test pattern is analyzed by control device 106. Robot 107 is controlled based on the analysis result, and is positioned at a predetermined orientation and position of liquid crystal panel 102.

Finally, joining device 110 is controlled by control device 106, and liquid crystal panel 102 is fixed to optical module 105, whereby optical module 105 can be adjusted.

### CITATION LIST

### Patent Literature

PTL 1: Unexamined Japanese Patent Publication No. H11-178014 A

### SUMMARY OF THE INVENTION

An examination method of an optical module according to an aspect of the present disclosure is an examination method of an optical module, the optical module including a display panel that displays a video and a projection lens that projects the video to be displayed on the display panel, the method sequentially including:
a test pattern display step of displaying, on the display panel, a test pattern including at least three or more dot-shaped light-on portions;
a test pattern receiving step of receiving, by a light receiving unit of a wavefront sensor, the test pattern including each light flux of the dot-shaped light-on portions projected from the projection lens;
a phase distribution calculation step of calculating, by a controller, a phase distribution of a wavefront of the test pattern received by the wavefront sensor;
a phase distribution cutting-out step of cutting out, by the controller, a region of each light flux of the dot-shaped light-on portions of the test pattern from the phase distribution of the wavefront;
a parallelism calculation step of calculating, by the controller, parallelism of light in the region of each light flux of the dot-shaped light-on portions cut out in the phase distribution cutting-out step; and
an inclination determination step of determining, by the controller, presence or absence of inclination of the display panel with respect to the projection lens from the parallelism of light in the region of each light flux.

### BRIEF DESCRIPTION OF THE DRAWINGS

FIG. 1 is a diagram schematically illustrating a configuration of an optical module of a transmissive liquid crystal projector.

FIG. 2 is a diagram schematically illustrating a simplified configuration of the optical module.

FIG. 3 is a diagram schematically illustrating an adjustment device of the optical module according to an exemplary embodiment of the present disclosure.

FIG. 4 is a flowchart illustrating an adjustment method of the optical module according to the exemplary embodiment of the present disclosure.

FIG. 5 is a diagram schematically illustrating an example of a test pattern of a display panel.

FIG. 6 is a diagram schematically illustrating a state in which the test pattern of FIG. 5 is projected on a light receiving unit of a wavefront sensor.

FIG. 7 is a diagram schematically illustrating a size relationship between the optical module and the light receiving unit of the wavefront sensor.

FIG. 8 is a diagram schematically illustrating a relationship between an intensity distribution of light and each light flux.

FIG. 9 is a diagram schematically illustrating an example in which the test pattern of the display panel includes three light-on portions.

FIG. 10 is a diagram schematically illustrating a state in which the test pattern of FIG. 9 is projected on the light receiving unit of the wavefront sensor.

FIG. 11 is a flowchart illustrating an adjustment method of the optical module with the test pattern of FIG. 9.

FIG. 12 is a diagram schematically illustrating an adjustment device of an optical module disclosed in PTL 1.

### DESCRIPTION OF EMBODIMENT

In the adjustment device for an optical module disclosed in PTL 1, it is necessary to form a video image of a test pattern on transmissive screen 108, and thus, it is necessary to align optical module 105 with transmissive screen 108 and camera 109, which are measurement units, and there is a problem that an adjustment time becomes long. In addition, since it is necessary to detect a slight change in the test pattern projected on transmissive screen 108 by camera 109, there is a problem that the position and orientation of liquid crystal panel 102 cannot be accurately adjusted.

An object of one aspect of the present disclosure is to provide an optical module adjustment method and an examination method capable of adjusting an optical module that projects light or video at high speed and with high accuracy.

In the following, exemplary embodiments of the present disclosure will be described with reference to the drawings. Note that the same reference numerals are given to the components common in the drawings, and the description thereof will be appropriately omitted.

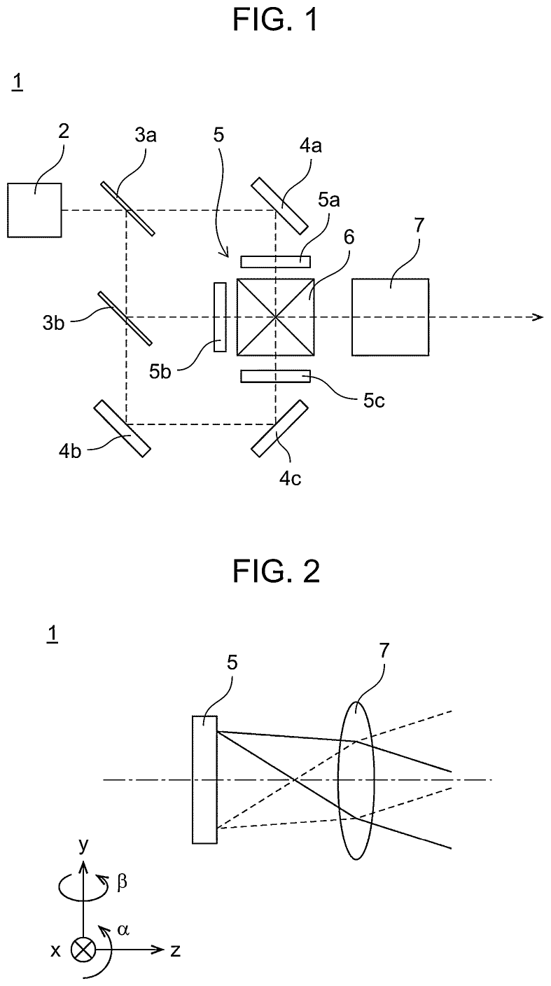

A representative example of an optical module according to an exemplary embodiment of the present disclosure will be described with reference to FIG. 1. FIG. 1 is a diagram schematically illustrating a configuration of optical module 1 of a transmissive liquid crystal projector.

Optical module 1 includes light source 2, first and second dichroic mirrors 3a and 3b, first, second, and third mirrors 4a, 4b, and 4c, first, second, and third display panels 5a, 5b, and 5c, prism 6, and projection lens 7.

The light emitted from light source 2 is transmitted only in red by first dichroic mirror 3a inclined with respect to the optical axis, and is incident on first display panel 5a through first mirror 4a. Light source 2 is, for example, a white light source such as a mercury lamp. Display panel 5 is a general term for first, second, and third display panels 5a, 5b, 5c, and specifically includes first, second, and third display panels 5a, 5b, 5c. Each of first, second, and third display panels 5a, 5b, 5c is, for example, a transmissive liquid crystal panel. First display panel 5a transmits light according to a pattern of a video, and projects a red video on a screen (not illustrated) through prism 6 and projection lens 7.

Similarly, among the light emitted from light source 2, the light reflected by first dichroic mirror 3a is separated into green and blue light by second dichroic mirror 3b inclined with respect to the optical axis. The green light is reflected by second dichroic mirror 3b, and projects a green video on the screen via second display panel 5b, prism 6, and projection lens 7. The blue light is transmitted through second dichroic mirror 3b, and projects a blue video on the screen via second and third mirrors 4b, 4c, third display panel 5c, prism 6, and projection lens 7.

As described above, optical module 1 displays video on the screen by superimposing each of the three videos of red, green, and blue.

In the assembly of optical module 1, it is necessary to adjust and assemble the projected video on a screen at a predetermined position from optical module 1 so as not to cause blurring. This means that positions and orientations of first, second, and third display panels 5a, 5b, 5c with respect to projection lens 7 of optical module 1 are adjusted.

FIG. 2 is a view schematically illustrating a simplified configuration of optical module 1 according to the exemplary embodiment of the present disclosure. The adjustment of optical module 1 adjusts the position and orientation of display panel 5, that is, first, second, and third display panels 5a, 5b, 5c with respect to the optical axis of projection lens 7. Here, the optical axis direction of projection lens 7 is z, the depth direction of the paper surface is x, the upward direction of the paper surface is y, the rotation direction around the x axis is α, and the rotation direction around the y axis is β. In the exemplary embodiment of the present disclosure, inclinations a and B with respect to the optical axis of display panel 5 and position z in the optical axis direction are adjusted. Hereinafter, in order to simplify the description, the description will be made using optical module 1 illustrated in FIG. 2.

Note that optical module 1 may have a configuration in which at least display panel 5 and projection lens 7 are mounted, and configurations of other optical components are not limited. In addition, although the configuration of optical module 1 of the transmissive liquid crystal projector has been described with reference to FIG. 1, any system may be used as long as it is an optical module that projects light or a video. For example, display panel 5 may have a configuration using a digital mirror device (DMD) or a liquid crystal on silicon (LCOS) that is a reflective panel, a light emitting diode (LED) panel that is a self-luminous panel, or an organic light emitting diode (OLED) panel. For example, although FIG. 1 illustrates an example of a three-plate system using three display panels 5, a single-plate system configuration using only one display panel 5 using light source 2 that sequentially switches colors using a color wheel or the like may be used.

Note that projection lens 7 of optical module 1 may constitute a part of a projection lens system of a product on which optical module 1 is mounted. For example, the video projected from projection lens 7 of optical module 1 may be optical module 1 of a product that further projects the video through another lens optical system.

Note that, in FIG. 2, projection lens 7 is illustrated as one lens in order to simplify the description, but projection lens 7 may include a plurality of lenses or optical components.

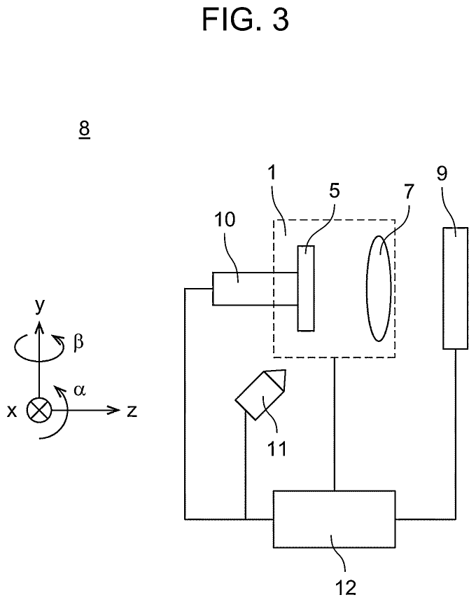

Next, a configuration of the adjustment device of optical module 1 according to the exemplary embodiment of the present disclosure will be described with reference to FIG. 3. FIG. 3 is a diagram schematically illustrating adjustment device 8 of optical module 1 according to the exemplary embodiment of the present disclosure.

Adjustment device 8 includes wavefront sensor 9 that measures light projected from optical module 1, positioning mechanism 10 that adjusts a position and an orientation of display panel 5, adhesion mechanism 11 that applies and fixes display panel 5 to optical module 1 with an adhesive, and controller 12 that controls wavefront sensor 9, positioning mechanism 10, and adhesion mechanism 11. Optical module 1 is being assembled, projection lens 7 is fixed to optical module 1, and display panel 5 is gripped by positioning mechanism 10. Here, wavefront sensor 9 is a sensor that directly measures the phase distribution of the wavefront of light, and for example, a Shack-Hartmann sensor using a microlens array or a wavefront sensor using sharing interference by a diffraction grating is used.

Wavefront sensor 9 is disposed at a position where light from optical module 1 does not form an image, and a distance between optical module 1 and wavefront sensor 9 is sufficiently shorter than a distance at which light from optical module 1 forms an image. This is because, since optical module 1 is generally an optical system that enlarges and projects the video of display panel 5, it is necessary to shorten the distance between optical module 1 and wavefront sensor 9 in order to collectively receive the test pattern of display panel 5 described later by wavefront sensor 9. Therefore, there is an effect that the adjustment device can be made small as compared with a conventional system of projecting light from optical module 1 onto a screen.

In addition, another optical component is not disposed between optical module 1 and wavefront sensor 9. This is because when another optical component is disposed between optical module 1 and wavefront sensor 9, the measurement accuracy decreases due to the influence of an error in the optical characteristics of these optical components or an error in alignment. By not arranging another optical component as described above, there is an effect that measurement can be performed with high accuracy.

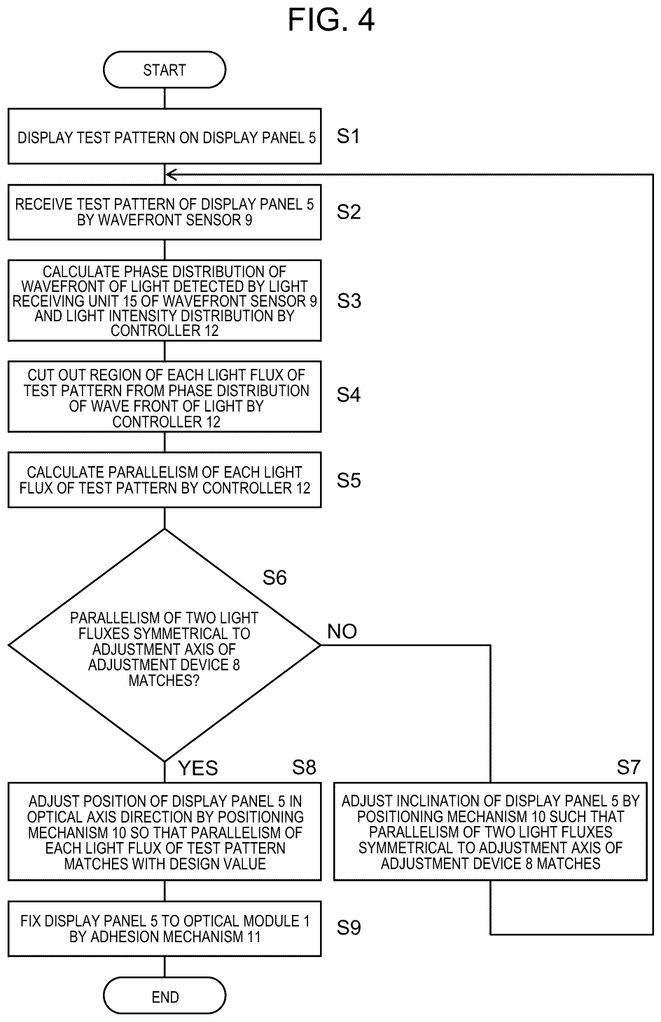

Next, an adjustment method of optical module 1 according to the embodiment of the present disclosure will be sequentially described with reference to a flowchart of FIG. 4. FIG. 4 is a flowchart illustrating an adjustment method of optical module 1 according to the exemplary embodiment of the present disclosure.

In step S1, a test pattern is displayed on display panel 5 according to a command from controller 12.

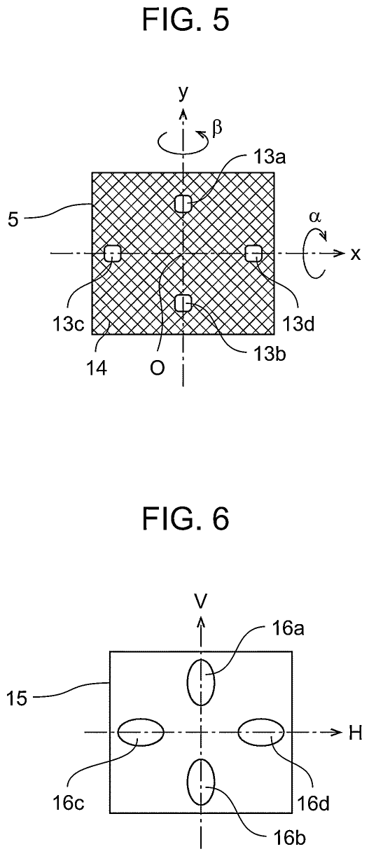

FIG. 5 is a diagram schematically illustrating an example of a test pattern of display panel 5. In FIG. 5, a horizontal direction of a paper surface is an x axis, a vertical direction is a y axis, an inclination around the x axis is α, and an inclination around the y axis is β. Point O is the center of the adjustment axis of adjustment device 8 and the optical axis of projection lens 7. The test pattern includes four light-on portions 13a, 13b, 13c, and 13d, which are white portions in FIG. 5, and a light-off portion 14, which is a cross-hatched portion in FIG. 5. Light-on portions 13a and 13b are arranged at symmetrical positions with respect to the x axis, and light-on portions 13c and 13d are arranged at symmetrical positions with respect to the y axis. In the exemplary embodiment of the present disclosure, light-on portions 13a and 13b are arranged on the y axis, and light-on portions 13c and 13d are arranged on the x axis. Since each of light-on portions 13a, 13b, 13c, and 13d is used as a point light source, it is preferable to light only one pixel. However, when the amount of light is insufficient, a plurality of pixels may be turned on and displayed as a dot-shaped pattern having a diameter of 50 μm or less. By adopting such a pattern, it can be regarded as an ideal point light source, and an error of a wavefront of light can be minimized in measurement to be described later, so that there is an effect that highly accurate measurement can be realized.

Next, in step S2, the test pattern of display panel 5 is received by wavefront sensor 9.

FIG. 6 is a diagram schematically illustrating a state in which the test pattern of FIG. 5 is projected on light receiving unit 15 of wavefront sensor 9. The horizontal direction of the paper surface is defined as an H axis, and the vertical direction is defined as a V axis. Here, the H axis and the V axis correspond to the x axis and the y axis in FIG. 5, respectively.

Light receiving unit 15 of wavefront sensor 9 receives light fluxes 16a, 16b, 16c, and 16d corresponding to light-on portions 13a, 13b, 13c, and 13d of the test pattern of FIG. 5, respectively. Since light-on portions 13a, 13b, 13c, and 13d are dot-shaped patterns, light fluxes 16a, 16b, 16c, and 16d are light fluxes in which ideal spherical wave light from the point light source passes through projection lens 7, respectively. In addition, since the distance between optical module 1 and wavefront sensor 9 is sufficiently shorter than the distance at which the light from optical module 1 forms an image, each of light fluxes 16a, 16b, 16c, and 16d is received as a spread light flux. In addition, since optical module 1 is generally an optical system that enlarges and projects a video of display panel 5, light fluxes 16a, 16b, 16c, and 16d are obliquely incident on the surface of light receiving unit 15 of wavefront sensor 9. In the exemplary embodiment of the present disclosure, for example, each of light fluxes 16a, 16b, 16c, and 16d is incident on light receiving unit 15 of wavefront sensor 9 in a state of being inclined by about 15 degrees with respect to the optical axis of projection lens 7. Therefore, each of light fluxes 16a, 16b, 16c, and 16d has an elliptical shape.

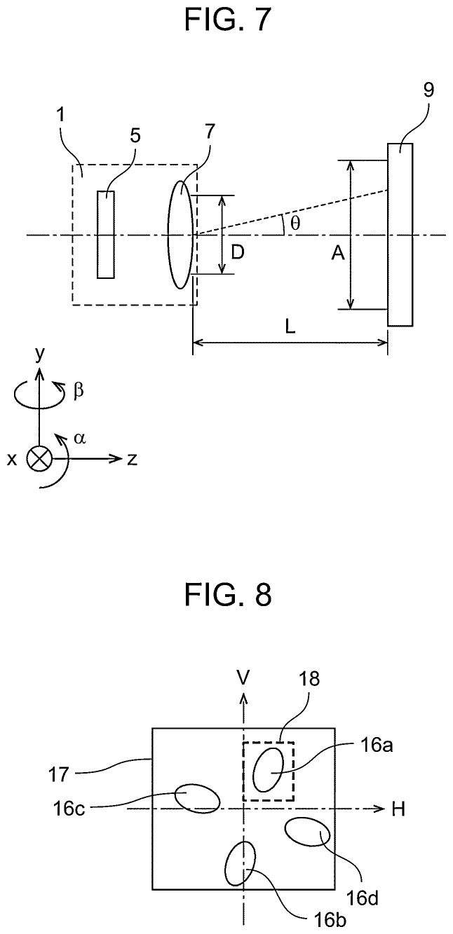

In addition, the size of light receiving unit 15 of wavefront sensor 9 needs to be a size capable of collectively receiving light fluxes 16a, 16b, 16c, and 16d. FIG. 7 is a diagram schematically illustrating a size relationship between optical module 1 and light receiving unit 15 of wavefront sensor 9. When the angle of view of the projection light of optical module 1 is θ, the effective diameter of projection lens 7 is D, and the distance between optical module 1 and wavefront sensor 9 is L, the size of light receiving unit 15 of wavefront sensor 9 is set to (2×L×tan θ+D) or more. By setting such a size of light receiving unit 15 of wavefront sensor 9, four light fluxes 16a, 16b, 16c, and 16d can be collectively received by one wavefront sensor 9, and there is an effect that adjustment and examination of optical module 1 can be performed at high speed. In addition, since the measurement can be performed with only one wavefront sensor 9, it is possible to eliminate the influence of the machine difference due to the use of the plurality of wavefront sensors 9 or the influence of the installation error between optical module 1 and wavefront sensor 9 due to the adjustment of the position of wavefront sensor 9, and there is an effect that the adjustment and examination of optical module 1 can be performed with high accuracy.

Next, in step S3, controller 12 calculates the phase distribution of the wavefront of the light detected by light receiving unit 15 of wavefront sensor 9 and the intensity distribution of the light. The phase distribution of the wavefront of light and the intensity distribution of light may be calculated by a known processing method of a Shack-Hartmann sensor or a wavefront sensor using sharing interference by a diffraction grating.

Next, in step S4, controller 12 cuts out the regions of light fluxes 16a, 16b, 16c, and 16d of the test pattern from the phase distribution of the wavefront of the light detected by light receiving unit 15 obtained in step S3.

Since the positional relationship between optical module 1 and wavefront sensor 9 in adjustment device 8 is determined in advance, the regions of light fluxes 16a, 16b, 16c, and 16d may be investigated and set in advance.

Next, in step S5, controller 12 calculates the parallelism of light fluxes 16a, 16b, 16c, and 16d of the test pattern.

The parallelism is a value representing a state of diffusion or convergence of light, and can be expressed by Formulas (1) and (2) using Dioptri-(unit: D, Diopter) representing the refractive power of the lens in the exemplary embodiment of the present disclosure.

$$D\_H = ( 4 √ 3 \cdot C\_Def + 2 √ 6 \cdot C\_ ( + As 3 ) ) / R \hat{} 2 \qquad ( 1 )$$

$$D\_V = ( 4 √ 3 \cdot C\_Def - 2 √ 6 \cdot C\_ ( + As 3 ) ) / R \hat{} 2 \qquad ( 2 )$$

Here, D_H and D_V are parallelism (unit: D) in the H-axis direction and the V-axis direction of light receiving unit 15 of wavefront sensor 9 illustrated in FIG. 6, respectively. In addition, R is the radius (unit: mm) of the beam of the light flux, and C_Def and C_(+As3) are the amount of defocus aberration in the optical axis direction (unit: μm) and the amount of astigmatism in the H-V direction (unit: μm) obtained by fitting the phase distribution of the wavefront of the light flux with a Zernike polynomial.

C_Def and C_(+As3) of each of light fluxes 16a, 16b, 16c, and 16d are calculated by controller 12 by performing fitting using the Zernike polynomial on the phase distribution of the wave front of the light in each region of each of light fluxes 16a, 16b, 16c, and 16d obtained in step S4. Since the positional relationship between optical module 1 and wavefront sensor 9 in adjustment device 8 is determined in advance, R of each of light fluxes 16a, 16b, 16c, and 16d may be investigated and set in advance.

As described above, the parallelism of each of light fluxes 16a, 16b, 16c, and 16d can be calculated by controller 12.

Next, in step S6, controller 12 determines whether or not the parallelism of the two light fluxes symmetrical to the adjustment axis of adjustment device 8 matches with each other.

Whether the parallelism matches is determined by controller 12 using a determination threshold previously recorded in controller 12. In a case where the difference in parallelism between the two light fluxes symmetrical with respect to the adjustment axis of adjustment device 8 is equal to or larger than the determination threshold, controller 12 determines that the parallelism does not match, and the processing proceeds to step S7. Otherwise, controller 12 determines that the parallelism matches, and the processing proceeds to step S8. This latter case means that the adjustment of the inclination of display panel 5 with respect to the optical axis of projection lens 7 is completed.

Therefore, in step S6, controller 12 examines presence or absence of inclination of display panel 5 with respect to the optical axis of projection lens 7. Up to this step, an examination method of optical module 1 is performed, and when the subsequent steps are included, an adjustment method of optical module 1 is performed.

In step S7, the inclination of display panel 5 is adjusted by positioning mechanism 10 such that the parallelism of the two light fluxes symmetrical to the adjustment axis of adjustment device 8 matches with each other.

As an example, a method for adjusting inclination a around the x axis of display panel 5 in FIG. 5 by positioning mechanism 10 will be described. When display panel 5 is inclined only in the a direction, there is a difference between the distance from light-on portion 13a of display panel 5 to projection lens 7 and the distance from light-on portion 13b of display panel 5 to projection lens 7. For this reason, the position where an image of light-on portion 13a is formed by projection lens 7 is different from the position where an image of light-on portion 13b is formed by projection lens 7. This is the same as that the parallelism of light flux 16a and the parallelism of light flux 16b received by wavefront sensor 9 of FIG. 6 are different. On the other hand, the state in which the inclination of display panel 5 is adjusted to the optical axis of projection lens 7 means that the position where the image of light-on portion 13a is formed by projection lens 7 and the position where the image of light-on portion 13b is formed by projection lens 7 matches with each other. Therefore, in order to adjust inclination a of display panel 5 and the optical axis of projection lens 7, the parallelism of light flux 16a and the parallelism of light flux 16b received by wavefront sensor 9 in FIG. 6 may be matched with each other.

Similarly, in order to adjust inclination B around the y axis of display panel 5 of FIG. 5, the parallelism of light flux 16c and the parallelism of light flux 16d received by wavefront sensor 9 in FIG. 6 may be matched with each other.

Controller 12 calculates the inclination adjustment amount from the parallelism of each of light fluxes 16a, 16b, 16c, and 16d, and issues a command to positioning mechanism 10 to adjust the inclination of display panel 5. The inclination adjustment amount by positioning mechanism 10 is determined on the basis of, for example, a database indicating a relationship between the parallelism of each light flux investigated in advance and the inclination adjustment amount.

After step S7 is completed, the processing returns to step S2, and steps S2 to S6 are performed again. Steps S2 to S6 are repeated until the difference in parallelism between the two light fluxes symmetrical to the adjustment axis of adjustment device 8 becomes smaller than the determination threshold in step S6.

Next, in step S8, the position of display panel 5 in the optical axis direction is adjusted by positioning mechanism 10 so that the parallelism of each light flux of the test pattern matches with the design value.

The image forming position of the video projected from optical module 1 is determined by design. Therefore, the parallelism of each of light fluxes 16a, 16b, 16c, and 16d emitted from projection lens 7 can also be determined by design.

Since the inclination of display panel 5 with respect to projection lens 7 has been adjusted up to step S6, in this step, display panel 5 is adjusted in the optical axis direction of projection lens 7, that is, in the z-axis direction of the coordinate system of FIG. 3 by positioning mechanism 10 so that the parallelism of each light flux matches with the design value. The adjustment amount in the z-axis direction by positioning mechanism 10 is determined by controller 12 on the basis of, for example, a database indicating the relationship between the parallelism of each light flux investigated in advance and the adjustment amount in the z-axis direction. In addition, steps S1 to S5 may be repeated, and controller 12 may adjust display panel 5 in the z-axis direction while monitoring the parallelism of each light flux.

Finally, in step S9, display panel 5 is fixed to optical module 1 by adhesion mechanism 11.

As described above, as the examination method of the optical module, the phase distribution of the wavefront of the test pattern projected from optical module 1 is calculated, the region of each light flux of the dot-shaped light-on portions of the test pattern is cut out from the phase distribution, the parallelism of the light of the cut-out region of each light flux is calculated, and the presence or absence of the inclination of display panel 5 with respect to projection lens 7 is determined from the parallelism of the light of the region of each light flux. As a result, when the adjustment method is performed thereafter, the orientation of display panel 5 of optical module 1 can be adjusted on the basis of the determination result so that the parallelism of each light flux matches, it is not necessary to form the video of the test pattern on the transmissive screen, and it is not necessary to detect a slight change in the test pattern projected on the transmissive screen with a camera. Therefore, optical module 1 that projects light or video can be adjusted at high speed and with high accuracy.

In the example of the test pattern of display panel 5 in FIG. 5, four light-on portions 13a, 13b, 13c, and 13d are simultaneously turned on. However, four light-on portions 13a, 13b, 13c, and 13d may be temporally divided and sequentially turned on. In this case, display of the test pattern on display panel 5 in step S1, and receiving of the test pattern of display panel 5 by wavefront sensor 9 in step S2 may be repeated for each light-on portion and recorded in controller 12.

In the flowchart of FIG. 4, the adjustment method of optical module 1 of one display panel 5 is illustrated, but the flowchart of FIG. 4 may be performed on each display panel 5 for optical module 1 including the plurality of display panels 5 as illustrated in FIG. 1. This is because the relationship between each display panel 5 and projection lens 7 is the same as the relationship between display panel 5 and projection lens 7 illustrated in FIG. 2.

In the flowchart of FIG. 4, as the adjustment method of optical module 1, the step of adjusting the inclination of display panel 5 in step S7, the step of adjusting the position of display panel 5 in the optical axis direction in step S8, and the step of fixing display panel 5 to optical module 1 in step S9 are described, but these steps may not be used in the case of the examination method of optical module 1. It is sufficient that there is the step of comparing the parallelism of the light fluxes in step S6. As described above, in the case of the examination method of optical module 1, when the comparison result or the determination result of comparing and determining the parallelism of the light fluxes in step S6 is obtained, the adjustment can be performed using the comparison result or the determination result, and the effect as the adjustment method of optical module 1 can be obtained.

Note that, in step S4, since the positional relationship between optical module 1 and wavefront sensor 9 in adjustment device 8 is determined in advance for each region, the example in which the region of each of light fluxes 16a, 16b, 16c, and 16d is investigated and set in advance has been described. However, a method of automatically extracting each region may be adopted. For example, a method may be adopted in which the region of each light flux is extracted by controller 12 from the light intensity distribution obtained in step S3 and each region is set.

FIG. 8 is a diagram schematically illustrating a relationship between light intensity distribution 17 obtained in step S3 and each of light fluxes 16a, 16b, 16c, and 16d. In the test pattern, since portions other than light fluxes 16a, 16b, 16c, and 16d are light-off portions, light intensity distribution 17 is a distribution in which there is intensity only in the regions of the light fluxes 16a, 16b, 16c, and 16d. Therefore, a portion having the intensity equal to or larger than the threshold recorded in advance in controller 12 is extracted as the region of the light flux, and the region of each light flux is set. By adopting such a method, even when there is an installation error between optical module 1 and wavefront sensor 9, the region of each of light fluxes 16a, 16b, 16c, and 16d can be accurately set, and there is an effect that highly accurate measurement can be realized.

Further, in FIG. 8, the region of each light flux may be set to an elliptical shape. This is because, as described in step S2, since optical module 1 is generally an optical system that enlarges and projects a video of display panel 5, light fluxes 16a, 16b, 16c, and 16d are obliquely incident on light receiving unit 15 of wavefront sensor 9, and light fluxes 16a, 16b, 16c, and 16d have an elliptical shape. For example, in the case of design in which light fluxes 16a, 16b, 16c, and 16d are incident on light receiving unit 15 of wavefront sensor 9 in a state of being inclined by about σ degrees with respect to the optical axis of projection lens 7, the ratio between the major axis and the minor axis may be set to 1:cos σ for the shape of the ellipse of the region of each light flux. In the exemplary embodiment of the present disclosure, since each light flux is incident on light receiving unit 15 of wavefront sensor 9 in a state of being inclined by about 15 degrees with respect to the optical axis of projection lens 7, σ may be set to 15 degrees, and the ratio between the major axis and the minor axis of the ellipse may be set to 1:0.97.

In addition, the position of the light flux may be determined by performing pattern matching on intensity distribution 17 using the elliptical shape as a master. Detection position 18 in FIG. 8 illustrates an example in which light flux 16a is detected by pattern matching. By adopting such a method, there is an effect that the position of the light flux can be accurately obtained as compared with the method of extracting a portion having the intensity equal to or larger than the threshold as the region of the light flux described above.

Furthermore, in step S5, the parallelism is calculated by fitting the phase distribution of the wavefront of the light flux with the Zernike polynomial, but the parallelism may be calculated by setting the region of each light flux to an elliptical shape and performing fitting with the elliptical Zernike polynomial. By adopting such a method, there is an effect that the phase distribution of the wavefront of each elliptical light flux can be accurately fitted, and the parallelism can be calculated with higher accuracy.

In step S1, as illustrated in FIG. 5, the test pattern includes four light-on portions 13a, 13b, 13c, and 13d, light-on portions 13a and 13b are arranged at positions symmetrical with respect to the x axis, and light-on portions 13c and 13d are arranged at positions symmetrical with respect to the y axis. However, the test pattern may include three light-on portions.

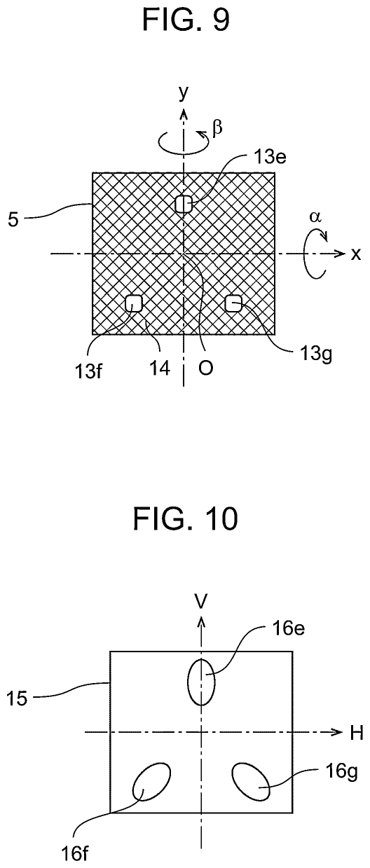

FIG. 9 is a diagram schematically illustrating an example in which the test pattern of display panel 5 includes three light-on portions. The test pattern includes three light-on portions 13e, 13f, and 13g and a light-off portion 14. Further, the distances from a point O which is the center of the adjustment axis of adjustment device 8 and is the optical axis of projection lens 7 to the three light-on portions 13e, 13f, and 13g are all equal. For example, three light-on portions 13e, 13f, and 13g can be arranged such that the centers thereof are located at positions of three vertexes of an equilateral triangle.

FIG. 10 is a diagram schematically illustrating a state in which the test pattern of FIG. 9 is projected on light receiving unit 15 of wavefront sensor 9. Light receiving unit 15 of wavefront sensor 9 receives light fluxes 16e, 16f, and 16g corresponding to light-on portions 13c, 13f, and 13g of the test pattern of FIG. 9, respectively.

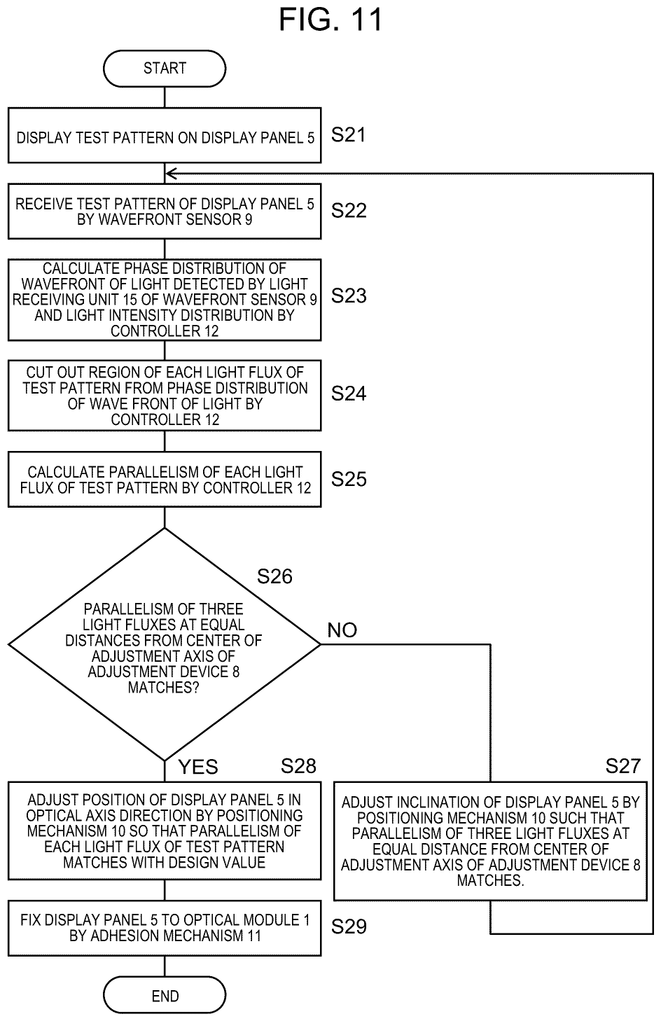

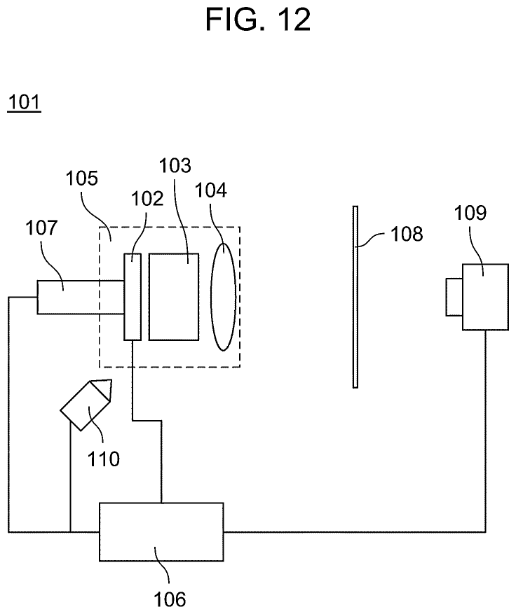

FIG. 11 is a flowchart illustrating an adjustment method of optical module 1 with the test pattern of FIG. 9. Steps S21 to S29 correspond to steps S1 to S9 in the flowchart of FIG. 4, respectively. Steps different from the flowchart of FIG. 4 are step S26 and step S27.

Next, in step S26, controller 12 determines whether the parallelism of the three light fluxes at the equal distance from the center of the adjustment axis of adjustment device 8 matches.

Whether the parallelism matches is determined by controller 12 using a determination threshold previously recorded in controller 12. When the difference in parallelism among the three light fluxes is equal to or larger than the determination threshold, it is determined that the parallelism does not match, and the processing proceeds to step S27. Otherwise, controller 12 determines that the parallelism matches, and the processing proceeds to step S28. In this case, it means that the adjustment of the inclination of display panel 5 with respect to the optical axis of projection lens 7 is completed. Therefore, in step S26, the presence or absence of the inclination of display panel 5 with respect to the optical axis of projection lens 7 is examined.

In step S27, the inclination of display panel 5 is adjusted by the positioning mechanism 10 under the control of controller 12 so that the parallelism of the three light fluxes at the equal distance from the center of the adjustment axis of adjustment device 8 matches.

As described above, controller 12 can perform the adjustment method of optical module 1 by using the test pattern including three light-on portions 130, 13f, and 13g. By adopting such a method, since the number of light fluxes received by light receiving unit 15 of wavefront sensor 9 can be reduced, there is an effect that it is easy to arrange the light-on portions of the test pattern of display panel 5 so that the regions of the light fluxes received by light receiving unit 15 of wavefront sensor 9 do not overlap.

Various aspects of the present disclosure will be described below.

### [First Aspect]

An examination method of an optical module, the optical module including a display panel that displays a video and a projection lens that projects the video to be displayed on the display panel, the method sequentially including:
a test pattern display step of displaying, on the display panel, a test pattern including at least three or more dot-shaped light-on portions;
a test pattern receiving step of receiving, by a light receiving unit of a wavefront sensor, the test pattern including each light flux of the dot-shaped light-on portions projected from the projection lens;
a phase distribution calculation step of calculating, by a controller, a phase distribution of a wavefront of the test pattern received by the wavefront sensor;
a phase distribution cutting-out step of cutting out, by the controller, a region of each light flux of the dot-shaped light-on portions of the test pattern from the phase distribution of the wavefront;
a parallelism calculation step of calculating, by the controller, parallelism of light in the region of each light flux of the dot-shaped light-on portions cut out in the phase distribution cutting-out step; and
an inclination determination step of determining, by the controller, presence or absence of inclination of the display panel with respect to the projection lens from the parallelism of light in the region of each light flux.

### [Second Aspect]

The examination method of the optical module according to the first aspect, wherein
the at least three or more dot-shaped light-on portions comprises four dot-shaped light-on portions,
the display step displays the test pattern including the four dot-shaped light-on portions, and arranges the dot-shaped light-on portions at positions symmetrical with respect to two axes orthogonal to each other on the display panel with a position where an optical axis of the projection lens passes through the display panel as an origin, and
the inclination determination step determines, by the controller, that there is an inclination of the display panel with respect to the projection lens when there is a difference in the parallelism among the respective light fluxes of the two dot-shaped light-on portions positioned symmetrically with respect to two axes orthogonal to each other on the display panel with the position where the optical axis of the projection lens passes through the display panel as an origin.

### [Third Aspect]

The examination method of the optical module according to the first aspect, wherein
the at least three or more dot-shaped light-on portions comprises three dot-shaped light-on portions,
the display step displays the test pattern including the three dot-shaped light-on portions, and arranges the three dot-shaped light-on portions at positions equidistant from a position where an optical axis of the projection lens passes through the display panel, and
the inclination determination step determines, by the controller, that there is an inclination of the display panel with respect to the projection lens when there is a difference in the parallelism among the light fluxes of the three dot-shaped light-on portions at positions equidistant from the position where the optical axis of the projection lens passes through the display panel.

### [Fourth Aspect]

The examination method of the optical module according to any one of the first to third aspects, in which the light receiving unit of the wavefront sensor has a size of (2×L×tan θ+D) or more,
where θ is an angle of view of projection light of the optical module,
D is an effective diameter of the projection lens, and
L is a distance between the optical module and the wavefront sensor.

### [Fifth Aspect]

The examination method of the optical module according to any one of the first to fourth aspects, in which the parallelism calculation step calculates, by the controller, the parallelism from defocus aberration and astigmatism.

### [Sixth Aspect]

The examination method of the optical module according to any one of the first to fifth aspects, in which the phase distribution cutting-out step forms the region of each light flux of the dot-shaped light-on portions into an elliptical shape, and calculates, by the controller, the parallelism using an elliptical Zernike polynomial.

### [Seventh Aspect]

An optical module adjustment method, including an inclination adjusting step of performing the examination method of the optical module according to any one of the first to sixth aspects, and when the inclination determination step determines, by the controller, that there is an inclination of the display panel, performing adjustment of the inclination of the display panel with respect to the projection lens by a positioning mechanism that adjusts the inclination of the display panel under the control of the controller such that parallelism of light in the region of each light flux of the dot-shaped light-on portions coincides.

### [Eighth Aspect]

The optical module adjustment method according to the seventh aspect, further including, after the inclination determination step, an optical axis direction adjusting step of moving the display panel in an optical axis direction of the projection lens and adjusting the display panel by adjusting a position of the display panel by the positioning mechanism under the control of the controller such that parallelism of light in the region of each light flux of the dot-shaped light-on portions matches with a design value of parallelism of the optical module.

Note that by appropriately combining arbitrary exemplary embodiments or modifications among the various exemplary embodiments or modifications described above, the effects of the respective exemplary embodiments or modifications can be achieved. In addition, combinations of exemplary embodiments, combinations of examples, or combinations of exemplary embodiments and examples are possible, and combinations of features in different exemplary embodiments or examples are also possible.

According to the present disclosure, as an examination method of an optical module, a phase distribution of a wavefront of a test pattern projected from the optical module is calculated, a region of each light flux of dot-shaped light-on portions of the test pattern is cut out from the phase distribution, a parallelism of light of the cut-out region of each light flux is calculated, and presence or absence of an inclination of the display panel with respect to the projection lens is determined from the parallelism of light of the region of each light flux. As a result, when the adjustment method is performed thereafter, the orientation of the display panel of the optical module can be adjusted based on the determination result so that the parallelism of each light flux matches, and it is not necessary to form the video of the test pattern on the transmissive screen, and it is not necessary to detect a slight change in the test pattern projected on the transmissive screen with the camera. Therefore, the optical module that projects light or video can be adjusted at high speed and with high accuracy.

### INDUSTRIAL APPLICABILITY

The optical module adjustment method and examination method according to the aspect of the present disclosure is useful for assembly adjustment of an optical module of a product that projects light or a video, for example, an optical module mounted on a liquid crystal projector, a head mounted display, smart glasses, a head-up display, or the like.

### REFERENCE MARKS IN THE DRAWINGS

1 optical module
2 light source
3a first dichroic mirror
3b second dichroic mirror
4a first mirror
4b second mirror
4c third mirror
5 display panel
5a first display panel
5b second display panel
5c third display panel
6 prism
7 projection lens
8 adjustment device
9 wavefront sensor
10 positioning mechanism
11 adhesion mechanism
12 controller
13a light-on portion
13b light-on portion
13c light-on portion
13d light-on portion
13e light-on portion
13f light-on portion
13g light-on portion
14 light-off portion
15 light receiving unit
16a light flux
16b light flux
16c light flux
16d light flux
16e light flux
16f light flux
16g light flux
17 intensity distribution
18 detection position
101 adjustment device
102 liquid crystal panel
103 prism
104 projection lens
105 optical module
106 control device
107 robot
108 transmissive screen
109 camera
110 joining device

1. An examination method of an optical module, the optical module including a display panel that displays a video and a projection lens that projects the video to be displayed on the display panel, the method sequentially including:
a test pattern display step of displaying, on the display panel, a test pattern including at least three or more dot-shaped light-on portions;
a test pattern receiving step of receiving, by a light receiving unit of a wavefront sensor, the test pattern including each light flux of the dot-shaped light-on portions projected from the projection lens;
a phase distribution calculation step of calculating, by a controller, a phase distribution of a wavefront of the test pattern received by the wavefront sensor;
a phase distribution cutting-out step of cutting out, by the controller, a region of each light flux of the dot-shaped light-on portions of the test pattern from the phase distribution of the wavefront;
a parallelism calculation step of calculating, by the controller, parallelism of light in the region of each light flux of the dot-shaped light-on portions cut out in the phase distribution cutting-out step; and
an inclination determination step of determining, by the controller, presence or absence of inclination of the display panel with respect to the projection lens from the parallelism of light in the region of each light flux.

2. The examination method of the optical module according to claim 1, wherein
the at least three or more dot-shaped light-on portions comprises four dot-shaped light-on portions,
the display step displays the test pattern including the four dot-shaped light-on portions, and arranges the dot-shaped light-on portions at positions symmetrical with respect to two axes orthogonal to each other on the display panel with a position where an optical axis of the projection lens passes through the display panel as an origin, and
the inclination determination step determines, by the controller, that there is an inclination of the display panel with respect to the projection lens when there is a difference in the parallelism among the respective light fluxes of the two dot-shaped light-on portions positioned symmetrically with respect to two axes orthogonal to each other on the display panel with the position where the optical axis of the projection lens passes through the display panel as an origin.

3. The examination method of the optical module according to claim 1, wherein
the at least three or more dot-shaped light-on portions comprises three dot-shaped light-on portions,
the display step displays the test pattern including the three dot-shaped light-on portions, and arranges the three dot-shaped light-on portions at positions equidistant from a position where an optical axis of the projection lens passes through the display panel, and
the inclination determination step determines, by the controller, that there is an inclination of the display panel with respect to the projection lens when there is a difference in the parallelism among the light fluxes of the three dot-shaped light-on portions at positions equidistant from the position where the optical axis of the projection lens passes through the display panel.

4. The examination method of the optical module according to claim 2, wherein the light receiving unit of the wavefront sensor has a size of (2×L×tan θ+D) or more,
where θ is an angle of view of projection light of the optical module,
D is an effective diameter of the projection lens, and
L is a distance between the optical module and the wavefront sensor.

5. The examination method of the optical module according to claim 2, wherein the parallelism calculation step calculates, by the controller, the parallelism from defocus aberration and astigmatism.

6. The examination method of the optical module according to claim 2, wherein the phase distribution cutting-out step forms the region of each light flux of the dot-shaped light-on portions into an elliptical shape, and calculates, by the controller, the parallelism using an elliptical Zernike polynomial.

7. An optical module adjustment method, comprising an inclination adjusting step of performing the examination method of the optical module according to claim 1, and when the inclination determination step determines, by the controller, that there is an inclination of the display panel, performing adjustment of the inclination of the display panel with respect to the projection lens by a positioning mechanism that adjusts the inclination of the display panel under the control of the controller such that parallelism of light in the region of each light flux of the dot-shaped light-on portions coincides.

8. The optical module adjustment method according to claim 7, further comprising, after the inclination determination step, an optical axis direction adjusting step of moving the display panel in an optical axis direction of the projection lens and adjusting the display panel by adjusting a position of the display panel by the positioning mechanism under the control of the controller such that parallelism of light in the region of each light flux of the dot-shaped light-on portions matches with a design value of parallelism of the optical module.
